(19) United States
(12) Patent Application Publication
(10) Pub. No.: US 2016/0244039 A1
(43) Pub. Date: Aug. 25, 2016

(54) VEHICULAR CRAWL MODE DECELERATION CONTROL

(71) Applicant: GM GLOBAL TECHNOLOGY OPERATIONS LLC, Detroit, MI (US)

(72) Inventors: Michael D. Rizzo, White Lake, MI (US); James S. Creehan, Dexter, MI (US); Paul S. Shaub, Detroit, MI (US); W. Marc Modisett, Waterford, MI (US); Mark C. Kohls, Farmington Hills, MI (US)

(73) Assignee: GM GLOBAL TECHNOLOGY OPERATIONS LLC, Detroit, MI (US)

(21) Appl. No.: 14/795,252

(22) Filed: Jul. 9, 2015

Related U.S. Application Data
(60) Provisional application No. 62/120,045, filed on Feb. 24, 2015.

(51) Int. Cl. B60T 8/32; B60T 7/12

(52) U.S. Cl. CPC B60T 8/322; B60T 7/12

(57) ABSTRACT

A vehicle includes an engine, an accelerator pedal, transmission, transfer case, mode selection device, road wheels, an electronic brake assembly, and a controller. The transfer case is connected to the transmission, and is operable for establishing a predetermined transfer case mode. The mode selection device receives a requested crawl mode of the vehicle in the predetermined transfer case mode. The electronic brake assembly has a brake motor and brake calipers, with each brake caliper disposed proximate a respective wheel to brake the respective road wheel. The controller is programmed to simulate a four-wheel drive-low mode of the transfer case in response to the requested crawl mode by decelerating the vehicle via control of the brake assembly and limiting a gear state of the transmission to 1^{st} or 2^{nd} gear. An auto-hold state may be engaged in crawl mode when the vehicle stops to prevent rolling of the vehicle.

### CROSS-REFERENCE TO RELATED APPLICATIONS

This application claims the benefit of U.S. Provisional Patent Application Ser. No. 62/120,045 which was filed on Feb. 24, 2015, which is hereby incorporated by reference its entirety.

### TECHNICAL FIELD

The present disclosure relates to vehicular crawl mode deceleration control.

### BACKGROUND

In an automotive powertrain, a transmission gearbox is used to transfer input torque to the vehicle's drive axles at a desired gear ratio. The drivetrain of a vehicle may be configured as a two-wheel drive (2WD) or a four-wheel drive (4WD) system, with the latter system providing improved traction on slippery or off-road driving surfaces. A 4WD powertrain includes a multi-speed transfer case that is connected to the transmission output shaft. One of the power flow arrangements of a multi-speed transfer case provides for a high-range 2WD mode, while the other arrangement provides for separate high-range and low-range 4WD modes, i.e., 4WD-high and 4WD-low modes, respectively.

In a transfer case configured with a 4WD-low mode, substantially higher amounts of torque are generated at lower engine speeds relative to operation in a 4WD-high mode. As a result, a vehicle operating in a 4WD-low mode is able to execute what is generally known in the art as a crawl maneuver, wherein vehicle speed is limited and higher amounts of torque are delivered to the four corners of the vehicle as a driver applies the brakes and requests throttle. Crawl mode may be desirable in certain driving conditions such as when towing a trailer, launching a boat, negotiating a relatively steep incline, or driving on loose or rocky surfaces. However, the inclusion of the additional transfer case hardware that is necessary for establishing true 4WD-low mode functionality comes at a cost of additional curb weight, packaging space, and mechanical design complexity.

### SUMMARY

A vehicle is disclosed herein that has a controller operable for simulating operation in a four-wheel drive (4WD)-low transfer case mode. The controller is programmed to selectively execute steps of a method in response to a requested crawl mode, and to thereby provide the benefit of more precise vehicle deceleration control relative to conventional approaches. The vehicle includes an electronic braking system in which a brake motor controls brake calipers disposed proximate to each of the road wheels of the vehicle, with the brake motor being responsive to a driver-requested braking signal applied to a brake pedal. The brake pedal is mechanically isolated from the brake motor and the brake calipers or other brake apply elements, i.e., the brake pedal is controlled by-wire as is well known in the art. Braking overlay signals are also selectively generated as needed by the controller during the crawl mode to provide additional vehicle deceleration at levels sufficient for mimicking 4WD-low driveline drag.

In an example embodiment, the vehicle includes an engine, an accelerator pedal, a transmission, a transfer case, a mode selection device, road wheels, an electronic brake assembly, and the controller noted above. The transfer case, which is connected to the transmission, is operable for establishing a predetermined transfer case mode such as 4WD-high or 2WD-high. The mode selection device receives a requested crawl mode of the vehicle.

The electronic brake assembly includes brake calipers or other brake apply elements disposed at each corner of the vehicle, or in other words, proximate a respective one of the road wheels. Each caliper is operable for braking a respective road wheel. A brake motor of the electronic brake assembly displaces fluid, with valves used to control brake pressure to the individual calipers as is known in the art, such that substantially equal amounts of brake pressure are applied across each drive axle. That is, for normal braking events the brake motor drives pressure to each corner of the vehicle with minimal valve control activity.

The controller is programmed to simulate a 4WD-low mode of the transfer case in response to the requested crawl mode from a predetermined transfer case mode, e.g., from 4WD-high or 2WD-high, decelerating the vehicle via automatic control of the electronic brake assembly, and limiting a gear state of the transmission, for instance to 1^{st} or 2^{nd} gear, while automatically applying smooth driveline drag via electronic braking control. Transmission gear limitation is intended to keep the vehicle in low gear to facilitate the deceleration control by limiting the number of gears needed for downshifting as the vehicle comes to a stop, and also when accelerating in crawl mode to help limit the top speed of the vehicle.

The controller may be optionally programmed to selectively disable auto-start/stop functionality of the engine during crawl mode. The controller may be programmed to engage an automatic “vehicle hold” mode via the electronic brake assembly after the vehicle has slowed to a stop so as to prevent the vehicle from rolling on an incline or creeping on a level surface, that is, to hold the vehicle stationary regardless of the apply state of a brake pedal so as to prevent rolling or creeping.

The vehicle may include a door switch sensor and a seat belt switch sensor. In such an embodiment, the controller may be programmed to engage an electronic parking brake and release the electronic brake assembly when the sensors detect an open door/unlatched seat belt condition while in the vehicle hold mode. In a vehicle having an electronic range selection device, a park pawl may be used to lock the transmission into a park mode in such a condition.

The vehicle according to another example embodiment includes an engine, an accelerator pedal which controls a throttle level of the engine, a transmission operatively connected to the engine, and a transfer case operatively connected to the transmission that is operable for establishing a predetermined transfer case mode. The vehicle also includes a mode selection device operable for receiving a requested crawl mode of the vehicle while in the predetermined transfer case mode, a plurality of road wheels, and an electronic brake assembly. The electronic brake assembly includes a brake motor and a plurality of calipers in fluid communication with the brake motor, with each caliper disposed proximate a respective one of the road wheels and operable for braking the respective road wheel.

A controller of the same vehicle is programmed to execute the requested crawl mode in the predetermined transfer case mode by simulating a four-wheel drive-low mode of the transfer case, including controlling the brake motor and calipers to decelerate the vehicle and limiting a gear state of the transmission to 1^{st} or 2^{nd} gear.

A corresponding method is also disclosed. The method in a particular embodiment includes receiving a requested crawl mode from a predetermined transfer case mode using a mode selection device in a vehicle having a transfer case and an electronic brake assembly. The electronic brake assembly brake calipers in fluid communication with a brake motor, with each brake caliper disposed in proximity to and operable for braking a respective road wheel. The method also includes executing the requested crawl mode while in the predetermined transfer case mode, via a controller, including simulating a 4WD-low mode of the transfer case via control of the brake motor and brake calipers to decelerate the vehicle and limiting a gear state of the transmission to 1^{st} or 2^{nd} gear.

In another embodiment, a vehicle includes an engine having auto-start/stop functionality, an accelerator pedal which controls a throttle level of the engine, and a transmission operatively connected to the engine. The vehicle also includes a transfer case operatively connected to the transmission, and operable for establishing a predetermined transfer case mode, with the predetermined transfer case mode being one of a four-wheel drive high mode and a two-wheel drive high mode. Additionally, the vehicle includes a mode selection device operable for receiving a requested crawl mode of the vehicle while in the predetermined transfer case mode, a plurality of road wheels, an electronic brake assembly having a brake motor and a plurality of calipers in fluid communication with the brake motor, wherein each caliper is disposed proximate a respective one of the road wheels and is operable for braking the respective road wheel.

In this embodiment, a controller is programmed to execute the requested crawl mode in the predetermined transfer case mode by simulating a four-wheel drive-low mode of the transfer case, including controlling the brake motor and calipers to decelerate the vehicle, limiting a gear state of the transmission to 1^{st} or 2^{nd} gear, and disabling the auto-start/stop functionality, and engaging an automatic vehicle hold function via control of the electronic brake assembly after the vehicle has slowed to a stop to prevent the vehicle from rolling.

The above features and advantages, and other features and advantages, of the present disclosure are readily apparent from the following detailed description of some of the best modes and other embodiments for carrying out the disclosure, as defined in the appended claims, when taken in connection with the accompanying drawings.

### BRIEF DESCRIPTION OF THE DRAWINGS

FIG. 1 is a schematic perspective view illustration of an example vehicle executing a crawl mode driving maneuver as set forth herein.

FIG. 2 is a schematic illustration of an example vehicle having a controller programmed with vehicle crawl mode deceleration control logic mimicking four-wheel drive-low mode as set forth herein.

FIG. 3 is a flow chart depicting an example method for controlling vehicle deceleration during a crawl mode in the vehicle of FIG. 1.

### DETAILED DESCRIPTION

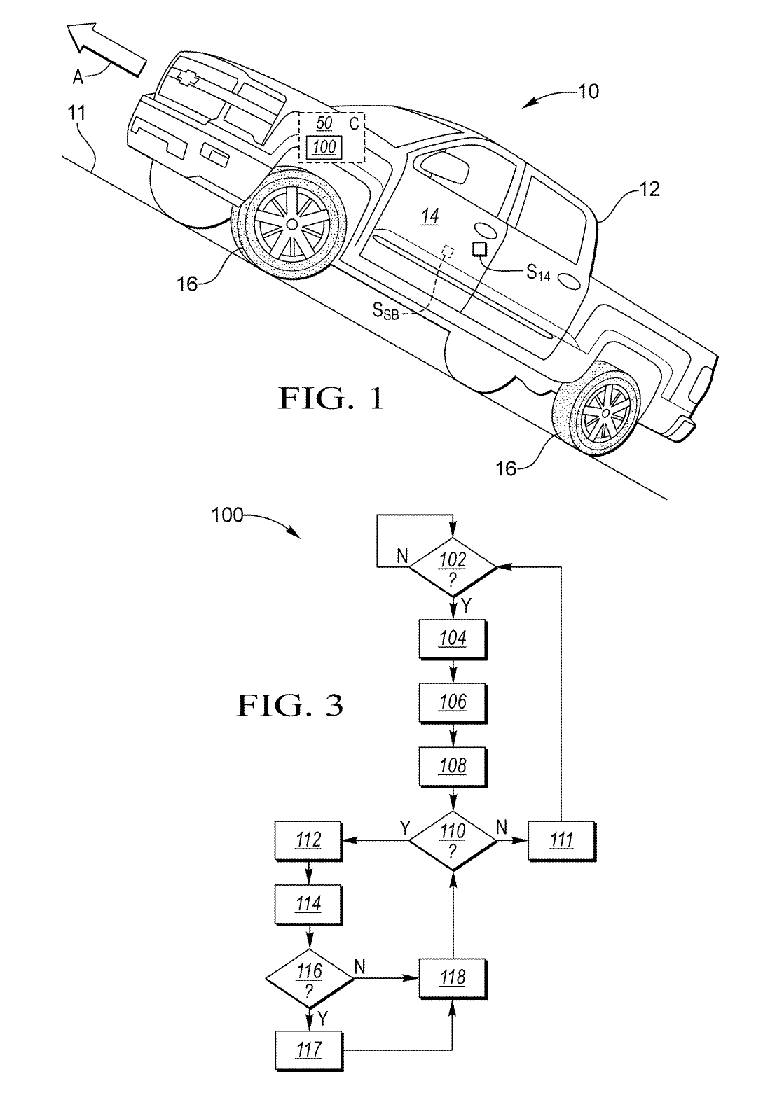

Referring to the drawings, wherein like reference numbers correspond to like or similar components throughout the several figures, and beginning with FIG. 1, an example vehicle 10 is shown in the process of executing an example crawl maneuver up an inclined surface 11, with the vehicle 10 moving as indicated by arrow A up the inclined surface 11 in a limited gear state and with a limited speed. The vehicle 10 is shown as an example pickup truck without limiting the design to such an embodiment. For instance, the vehicle 10 may be alternatively embodied as a sport utility vehicle, a crossover vehicle, a sedan, a coupe, or any other style of vehicle having a controller (C) 50 programmed with steps of a method 100 as set forth herein.

The vehicle 10 includes a body 12, doors 14 having door switch sensors (S₁₄) and seat belt switch sensors (S_{SB}), with the door switch sensors (S₁₄) and seat belt switch sensors (S_{SB}) respectively detecting a closed/latched state of the doors 14 and seat belts (not shown), as is known in the art. The vehicle 10 also includes a set of road wheels 16, some or all of which may be powered as drive wheels depending on the embodiment. The vehicle 10 may be equipped with four-wheel drive (4WD)-high functionality, two-wheel drive (2WD)-high functionality, or true 4WD-low functionality without departing from the intended inventive scope.

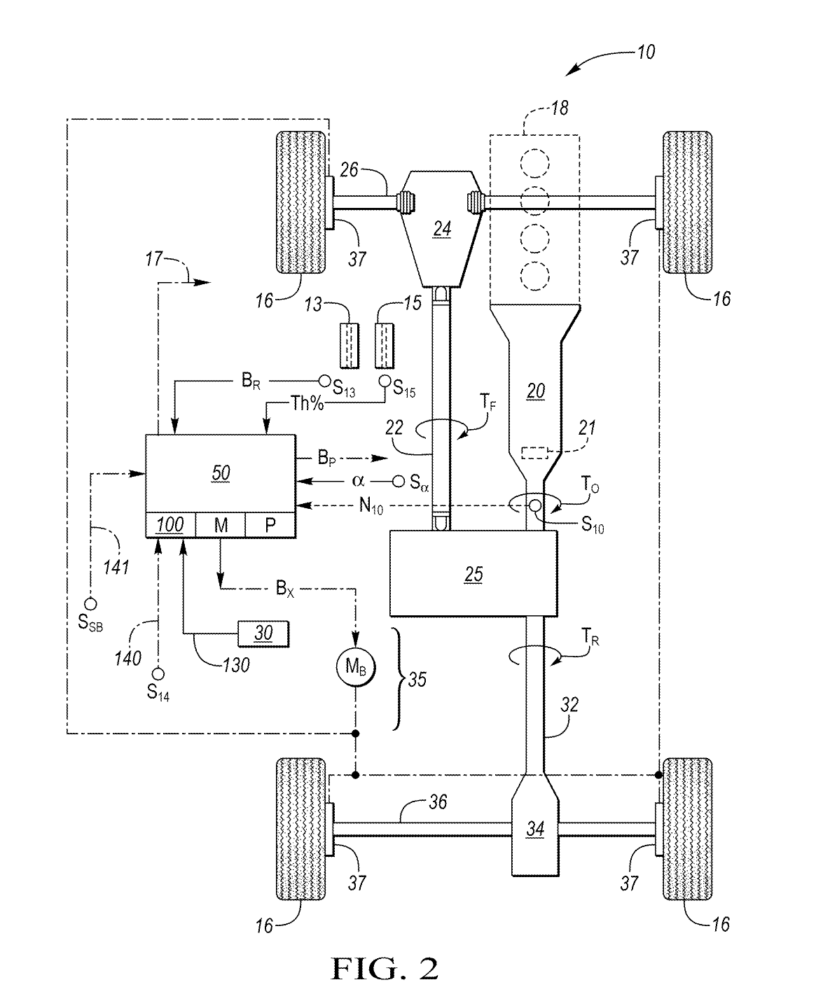

As explained below with particular reference to FIGS. 2 and 3, the controller 50 is programmed to simulate or mimic the feel and performance of 4WD-low mode while executing a vehicular crawl maneuver. Such a maneuver is initiated via selection of crawl mode by a driver of the vehicle 10. As used herein, the term “crawl mode” refers to a powertrain mode in which the vehicle 10 is allowed to move at a calibrated limited speed, e.g., about 10-20 KPH, without braking input on the part of the driver of the vehicle 10, and with acceleration control still afforded to the driver as set forth below. Such a mode may be desirable while moving up steep terrain as shown in FIG. 1 or while maneuvering a trailer, for instance when slowly backing down a ramp to launch a boat.

The controller 50 is therefore specially programmed with control logic embodying the method 100 which, upon its execution, simulates the 4WD-low mode when crawl mode is affirmatively selected. As explained below in detail with reference to FIGS. 2 and 3, when a driver releases throttle the controller 50 automatically commands driveline drag to be smoothly applied at the road wheels 16 via electronic braking. In crawl mode, the controller 50, e.g., an engine control module (ECM) portion of the controller 50 in an example vehicular distributed control network, uses a unique throttle map with respect to pedal position in addition to altering a transmission shift pattern and top gear allowed, as set forth below.

In addition to this deceleration control functionality, the controller 50 selectively enters a vehicle hold mode when the vehicle 10 eventually comes to a stop in the crawl mode, such that the vehicle 10 remains stationary on an incline or a decline even when a brake pedal 13 as shown in FIG. 2 is released. Using signals from the door switch sensors S₁₄ and/or seat belt switch sensors S_{SB}, the controller 50 may also engage an electronic parking brake when one of the doors 14 is opened and/or a seat belt (not shown) is unlatched in the vehicle hold state. Under other drive conditions, the controller 50 may enable more aggressive corner braking, e.g., when executing a rock-crawling maneuver. The above-described functionality will now be described in further detail with reference to FIGS. 2 and 3.

Referring to FIG. 2, in a possible design the vehicle 10 of FIG. 1 may include an internal combustion engine 18, a transmission 20, and the controller 50. The engine 18 may be connected to the transmission 20 via an input clutch (not shown), e.g., a manual input clutch in the example of a manual transmission or a hydrodynamic torque converter in the example of an automatic transmission. Although omitted for illustrative simplicity, those of ordinary skill in the art will appreciate that the transmission 20 may include various planetary gear sets, clutches, brakes, a park pawl 21, return springs, and hydraulic circuit components necessary for establishing a desired gear state and delivering output torque (arrow T_{O}) to the driveline. Additionally, a parking brake signal (arrow B_{P}) is commanded to engage an emergency or electronic parking brake as set forth below with reference to FIG. 3.

The vehicle 10 of FIG. 1 may include a front drive shaft 22, a front differential 24, and a front drive axle 26 as shown, as well as a rear drive shaft 32, a rear differential 34, and a rear drive axle 36. In such an embodiment, a transfer case 25 may be used to split power between the respective front and rear axles 26 and 36, as indicated via arrows T_{F} and T_{R}, respectively, with the transfer case 25 containing various drive chains, gear sets, clutches, and the like.

With respect to braking of the vehicle 10, the vehicle 10 utilizes an electronic brake assembly 35, which as used herein refers to a brake motor M_{B} and individual brake calipers 37, or any other suitable brake apply mechanism disposed proximate the wheels 16. The brake motor M_{B} may be embodied as a solenoid device or other suitable motor design operatively displacing brake fluid to the corners of the vehicle 10, for instance via valves, brake lines, and the like (not shown) as is well known in the art, to thereby control an engaged/released state of the calipers 37. The use of the electronic brake assembly 35 maintains even deceleration at the corners of the vehicle 10, or in other words applies substantially equal amounts of brake pressure across each axle of the vehicle 10 to prevent leading or pulling.

The electronic brake assembly 35 is responsive to a driver-requested braking signal (arrow B_{R}) as applied to the brake pedal 13. However, unlike conventional vacuum-driven hydraulic braking systems in which a vacuum brake booster is used to reduce the amount of force a driver has to apply to the brake pedal 13, the brake pedal 13 is isolated from the brake calipers 37 of the electronic brake assembly 35, i.e., the connection between the brake pedal 13 and the brake motor M_{B} and calipers 37 is achieved solely by-wire via the controller 50 during normal operation of the vehicle 10. The brake calipers 37 are used to slow rotation of the road wheels 16, and thus use the brake motor M_{B} as an electronic actuator instead of using a hydraulic cylinder, with the process governed directly by the controller 50 instead of via a high-pressure brake master cylinder.

Thus, in electronic braking a driver applies a desired amount of pressure or travel to the brake pedal 13, which is automatically detected via a brake pedal sensor S₁₃, in order to command the driver-request braking signal (arrow B_{R}). As is known in the art, in the unlikely event an electronic braking system such as that shown schematically in FIG. 2 loses power, mechanical backup braking capability is retained, such as by changing a valve position to enable the driver to manually brake the vehicle 10 to a stop. Otherwise, the brake pedal 13 remains mechanically isolated from the electronic brake assembly 35, which is an advantage used by the controller 50 in providing a smooth braking feel during deceleration control and avoiding brake pedal pulsation disturbances while operating in crawl mode.

The vehicle 10 of FIG. 2 also includes an accelerator pedal 15 operable for outputting a throttle request (arrow Th %) to the controller 50, e.g., as determined via a throttle sensor (S₁₅), and a mode selection device 30 configured to receive a mode selection input signal (arrow 130). The mode selection device 30 may be embodied as a knob, button, or lever disposed in an interior of the vehicle 10, or a touch-screen device, with the mode selection device 30 being any device operable for requesting execution of the crawl mode. Additionally, the door switch sensors S₁₄ and seat belt sensors S_{SB} noted briefly above with reference to FIG. 1 are in communication with the controller 50 and operable for outputting a corresponding open/closed state signal (arrow 140, 141) to the controller 50 as part of the method 100.

The controller 50 may be configured as a microprocessor-based computing device or devices each having memory (M) and a processor (P). While depicted as a single controller 50 in FIG. 2 for illustrative simplicity, in practice the controller 50 may be embodied as multiple control modules, such as a body control module (BCM), an electronic braking control module (eBCM), a transmission control module (TCM), an engine control module (ECM), and the like, as is known in the art, with each control module in communication with the others via a controller area network (CAN) bus or other suitable communication channels.

The memory (M) includes a tangible, non-transitory memory device on which is recorded instructions embodying the method 100, an example of which is shown in FIG. 3 and explained below. In addition to the memory (M) and processor (P), the controller 50 may include additional circuitry including but not limited to a high-speed clock, analog-to-digital circuitry, digital-to-analog circuitry, a digital signal processor, and any necessary input/output devices and other signal conditioning and/or buffer circuitry.

The controller 50 of FIG. 2 is programmed to selectively output brake control signals (arrow B_{X}) to each of the electronic brake assembly 35 as part of the method 100, with the brake control signals (arrow B_{X}) being defined herein as the driver-requested braking signal (arrow B_{R}) applied to the brake pedal 13 in addition to an automatically-generated braking overlay value generated by the controller 50. Braking control occurs in response to various vehicle parameters to produce drag on the driveline when a driver, via the mode selection device 30, affirmatively requests the crawl mode. Such vehicle parameters may include the present vehicle speed (arrow N₁₀), e.g., as measured via a speed sensor (S₁₀) such as a transmission output speed sensor or individual wheel speed sensors, throttle level (arrow Th %), the driver-requested braking signal (arrow B_{R}), and road grade (arrow α), e.g., as determined via a low-G longitudinal accelerometer Sₙ. Such a device may be a capacitive sensor outputting a voltage signal representing a tilt angle, with the change in degrees of tilt corresponding to a change in acceleration due to a changing component of gravity acting on the accelerometer Sₙ. The controller 50 may also be programmed to selectively disable engine auto start/stop functionality via an engine control signal (arrow 17) as set forth below.

Referring to FIG. 3, an example embodiment is shown of the method 100. As noted above, the method 100 allows for simulation of a 4WD-low mode via automatic imposition of driveline drag via braking control, along with automatic execution of a vehicle hold state when the brake pedal 13 of FIG. 2 is released after a stop. Thus, when a driver requests crawl mode and applies or releases the accelerator pedal 15, the controller 50 of FIGS. 1 and 2 controls the electronic brake assembly 35 disposed at the corners of the vehicle 10 along with taking other control actions.

Beginning with step 102, a driver of the vehicle 10 of FIG. 1 selects the crawl mode using the mode selection device 30 of FIG. 2, with entry into the crawl mode permitted to occur from a predetermined transfer case mode such as 4WD-high or 2WD-high. In various embodiments, step 102 may include turning a mode selection knob or moving a mode selection lever to a corresponding “crawl mode” setting, or touching a corresponding icon or button on a touch screen device, so as to generate the mode selection input signal (arrow 130) and thereby signal to the controller 50 that the driver wishes to enter crawl mode. The method 100 proceeds to step 104 upon receipt of the mode selection input signal (arrow 130) by the controller 50.

Step 104 entails ensuring the transfer case 25 of FIG. 2 is in the predetermined transfer case mode. The predetermined mode depends upon the particular configuration of the transfer case 25. For instance, in a 4WD embodiment step 104 may include ensuring that a 4WD-high mode or a 4WD-low mode are active, while in a 2WD embodiment step 104 may entail shifting to a 2WD-high mode. Method 100 proceeds to step 106 once the predetermined transfer case mode is verified. Step 104 is essentially redundant with step 102, but may be used to ensure that the rest of method 100 proceeds only in crawl mode in the predetermined transfer case mode.

At step 106, the controller 50 may optionally disable engine auto-stop/start functionality via the engine control signal (arrow 17) of FIG. 2. As is known in the art, auto-stop/start is an engine control function that reduces idle fuel consumption by shutting off the engine 18 when the vehicle 10 is idling at a standstill. Since auto-start is typically triggered by a driver removing pressure from the brake pedal 13 and applying pressure to the accelerator pedal 15, such a function may interfere with control of the crawl mode in certain applications, and therefore the controller 50 may be programmed to temporarily disable auto-stop/start functionality in some embodiments. The method 100 then proceeds to step 108.

Step 108 includes accessing a predetermined unique throttle map from memory (M) of the controller 50, with the throttle map, as is known in the art, indexing commanded engine torque to a particular level of throttle or position/travel of the accelerator pedal 15. Step 108 also includes accessing a predetermined shift strategy or gear shift pattern recorded as logic in the memory (M) of controller 50, e.g., a transmission control module portion of the controller 50. The shift strategy controls, for the duration of the crawl mode, gear shifts of the transmission 20 that are permitted during crawl mode, as well as the timing of such shifts. As part of this strategy the transmission 20 is permitted to be shifted in crawl mode only as high as a predetermined maximum allowable gear. For instance, in an example 8-speed transmission the maximum gear may be 1^{st} gear, while a higher-speed transmission may use 1^{st} or 2^{nd} gear as the maximum gear. Collectively, the maximum gear, throttle map, and shift strategy govern the states and modes of the powertrain while in crawl mode, with a blending of brakes/throttle used to ensure optimal smoothness of the braking action. The method 100 then proceeds to step 110 as crawl mode initiates.

At step 110, the controller 50 determines if the accelerator pedal 15 of FIG. 2 has been released while operating in crawl mode. Step 110 may include processing the throttle signal (arrow Th %) to determine if zero or a calibrated low non-zero amount of throttle is being requested. If so, the method 100 proceeds to step 112. If more than the threshold zero or non-zero throttle is still being applied, the method 100 may proceed in the alternative to step 111.

Step 111 includes executing a traction control system (TCS) “rock crawl” mode. In such a mode, the controller 50 uses traction control calibration biased towards aggressively applying brake torque on a slipping wheel 16 to allow more propulsion torque to reach the wheel(s) that are not slipping. The level of aggressiveness in applying the brakes is effective for maximum rock crawling capability, but may not be desirable to a driver during normal driving conditions when the wheels 16 are slipping.

As part of step 111 the controller 50 may reference a different version of the throttle map and shift strategy logic from memory (M) than that previously accessed at step 108. The throttle map and shift strategy logic of step 111 are configured to optimize torque transfer to the corners of the vehicle 10. The method 100 repeats steps 102-110 while in rock crawling mode. When the accelerator pedal 15 is released at step 110, and if such a release is sustained for a calibrated duration to ensure that throttle release is not merely intermittent, the method 100 proceeds to step 112.

At step 112 the controller 50 smoothly decelerates the vehicle 10 to a stop via control of the electronic brake assembly 35, doing so as a calibrated function of the present gear state, vehicle speed, and road grade. The calibrated function may vary with the design of the vehicle 10 and the desired braking feel. Step 112 occurs via transmission of the brake control signals (arrow B_{X}) to the brake motor M_{B} and calipers 37. As noted above with reference to FIG. 2, the brake control signals (arrow B_{X}) may include the driver-requested braking signal (arrow B_{R}). That is, a driver may still attempt to brake the vehicle 10 to a stop in crawl mode, and therefore the controller 50 generates as much of a braking overlay to the driver-requested braking signal (arrow B_{R}) as is needed to smoothly slow the vehicle 10 to a stop at a calibrated rate.

Because the braking system is electronic, and thus the brake pedal 13 is isolated from the electronic brake assemblies 35, pulsations and other undesirable feedback to the driver through the brake pedal 13 during the braking process should be imperceptible to the driver. In other words, any automatically-generated braking control signals from the controller 50 in addition to those generated in response to the driver's own driver-requested braking signal (arrow B_{R}) should be smoothly applied and imperceptible to the driver, which is made possible largely due to the isolation of the brake pedal 13.

In the event the powertrain of vehicle 10 is a hybrid powertrain, step 112 may also entail coordinated control of electronic braking elements of such a powertrain, e.g., motor torque delivered to the driveline. For instance, the controller 50 may temporarily prevent regenerative braking to minimize driveline torque disturbances in crawl mode. In such an embodiment, the controller 50 may communicate with a hybrid control module (HCM) and/or a motor control processor to ensure that power generation does not occur in creep mode, or is otherwise closely coordinated with creep mode if such function is to be retained. Alternatively, the controller 50 may coordinate the amount of regenerative braking that is used with the amount of electronic braking that is applied via the electronic brake assembly 35 so as to generate a desired amount of deceleration of the vehicle 10. The method 100 proceeds to step 114 when the vehicle 10 has stopped.

Step 114 includes engaging the vehicle auto-hold mode or function noted briefly above. When the vehicle 10 stops, the vehicle 10 is prevented from moving forward or rolling back down the incline 11 of FIG. 1 via operation of the electronic brake assembly 35, such that the vehicle 10 is not allowed to roll on an incline. Likewise, on a level surface the hold function can be used to prevent creeping. This occurs even when the driver releases the brake pedal 13, and is accomplished via automatic adjustment by the controller 50 of the brake control signals (arrow B_{X}). The method 100 proceeds to step 116 once the auto-hold mode is engaged.

At step 116 the controller 50 may determine whether a door 14 of FIG. 1 is open and a seat belt (not shown) is unlatched, such as via processing of the open/closed state signals (arrows 140, 141) from the respective door switch sensors S₁₄ and seat belt switch sensor S_{SB}. A purpose of step 116 is to ensure that the vehicle 10 is prevented from rolling back down the incline 11 of FIG. 1 if the driver exits the vehicle 10 while still in auto-hold, e.g., to attend to a trailer or boat launch action. Detection of an open door 14, and/or detection of an unlatched seat belt is therefore used to determine if the auto-hold state engaged at step 114 is likely to be sustained for an extended period of time. If the auto-hold state is maintained for more than a calibrated duration, e.g., as determined via the open door 14 and/or via expiration of a timer of the controller 50, the method 100 proceeds to step 117. Otherwise, if the door 14 remains closed and/or the timer noted above does not expire, the method 100 may proceed in the alternative to step 118.

Step 117 entails transmitting, via the controller 50 of FIG. 2, the parking brake signal (arrow B_{P} of FIG. 1) to thereby command setting or engagement of the parking brake, e.g., an electronically-actuated parking brake of the type known in the art. This action allows the electronic brake assembly 35 to be released and braking of the vehicle 10 to occur via the emergency parking brake, that is, a direct engagement of the brake calipers 37 via a mechanical linkage (not shown) or engagement of the park pawl 21, thereby reducing the load on the electronic brake assembly 35 during a sustained holding of the auto-hold function. The vehicle 10 can remain in this state as long as necessary, with the method 100 thereafter proceeding to step 118.

At step 118, the controller 50 may release the electronic parking brake set at step 117, or ensure that the parking brake remains released if step 118 is arrived at from step 116. Step 118 may be performed by transmitting the parking brake signal (arrow B_{P} of FIG. 1) to command release of the parking brake. The electronic parking brake will release if the driver uses the accelerator pedal 15 to command motion of the vehicle 10. The method 100 then proceeds to step 110.

Using the controller 50 and method 100 described above, and using available electronic braking functionality, 4WD-low mode may be mimicked in a vehicle powertrain. As described above, when in crawl mode the vehicle 10 of FIGS. 1 and 2 will shift the transfer case 25 into 4WD-high, AWD, 2WD-high, or 4WD-low transfer case mode, apply a unique throttle map and transmission shift strategy, and limit the top transmission gear state that is allowed. Additionally, the controller 50 may selectively disable engine auto-start/stop and enable rock crawling in 4WD-high. As part of the described strategy, the controller 50 performs lift throttle deceleration when the driver releases the accelerator pedal 15 so as to brake the vehicle 10 to a stop, and thereafter engages the automatic vehicle hold function. In this manner, the ability is afforded of controlling vehicle deceleration in the same precise manner as is available with 4WD-low transfer cases when the vehicle 10 is in 4WD-high, 2WD-high, or 4WD-auto/AWD, thereby potentially foregoing the use of 4WD-low transfer case components and their associated weight, complexity, and packaging space requirements.

As used herein with respect to any disclosed values or ranges, the term “about” indicates that the stated numerical value allows for slight imprecision, e.g., reasonably close to the value or nearly, such as ±10 percent of the stated values or ranges. If the imprecision provided by the term “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A vehicle comprising:
an engine;
an accelerator pedal which controls a throttle level of the engine;
a transmission operatively connected to the engine;
a transfer case operatively connected to the transmission and configured to establish a predetermined transfer case mode;
a mode selection device operable for receiving a requested crawl mode of the vehicle while the transfer case is in the predetermined transfer case mode;
a plurality of road wheels;
an electronic brake assembly having a brake motor and a plurality of brake calipers in fluid communication with the brake motor, wherein each brake caliper is disposed proximate a respective one of the road wheels and operable for braking the respective road wheel; and
a controller in communication with the mode selection device, and programmed to execute the requested crawl mode by simulating a four-wheel drive-low mode of the transfer case, including controlling the brake motor and the brake calipers to thereby decelerate the vehicle and limit a gear state of the transmission to 1^{st} or 2^{nd} gear.

2. The vehicle of claim 1, wherein the engine has auto-start/stop functionality, and wherein the controller is programmed to selectively disable the auto-start/stop functionality during the crawl mode.

3. The vehicle of claim 1, wherein the controller is programmed to engage an automatic vehicle hold function via control of the electronic brake assembly after the vehicle has slowed to a stop in the crawl mode to thereby prevent the vehicle from rolling on an inclined surface.

4. The vehicle of claim 1, wherein the predetermined transfer case mode is a four-wheel drive high mode.

5. The vehicle of claim 1, wherein the predetermined transfer case mode is a two-wheel drive high mode.

6. The vehicle of claim 1, further comprising a door switch sensor, wherein the controller is programmed to engage a parking brake and release the electronic brake assembly when the door switch sensor detects an open door of the vehicle.

7. The vehicle of claim 6, further comprising a seat belt switch sensor, wherein the controller is programmed to engage the parking brake and release the electronic brake assembly when the door switch sensor detects the open door of the vehicle and the seat belt switch sensor detects an unlatched seat belt of the vehicle.

8. A method comprising:
receiving a requested crawl mode of a vehicle from a predetermined transfer case mode using a mode selection device, wherein the vehicle includes a transfer case and an electronic brake assembly having a brake motor and a plurality of brake calipers in fluid communication with the brake motor, with each brake caliper disposed proximate a respective one of the road wheels and operable for braking the respective road wheel; and
executing the requested crawl mode while in the predetermined transfer case mode, via a controller, including simulating a four-wheel drive-low mode of the transfer case via control of the brake motor and calipers to decelerate the vehicle and limiting a gear state of the transmission to 1^{st} or 2^{nd} gear.

9. The method of claim 8, wherein the vehicle has an engine with auto-start/stop functionality, the method further comprising selectively disabling the auto-start/stop functionality during the crawl mode.

10. The method of claim 8, further comprising automatically engaging a vehicle hold mode while in the crawl mode, via control of the electronic brake assembly by the controller, after the vehicle has slowed to a stop, wherein the vehicle hold mode prevents rolling of the vehicle on an inclined surface.

11. The method of claim 8, wherein the predetermined transfer case mode is a four-wheel drive high mode.

12. The method of claim 8, wherein the predetermined transfer case mode is a two-wheel drive high mode.

13. The method of claim 8, wherein the vehicle includes a door switch sensor, the method further comprising engaging a parking brake and releasing the electronic brake assembly when the door switch sensor detects an open door of the vehicle.

14. The method of claim 13, wherein the vehicle includes a seat belt switch sensor, the method further comprising engaging the parking brake and releasing the electronic brake assembly when the door switch sensor detects the open door of the vehicle and the seat belt switch sensor detects an unlatched seat belt of the vehicle.

15. A vehicle comprising:
an engine having auto-start/stop functionality;
an accelerator pedal which controls a throttle level of the engine;
a transmission operatively connected to the engine;
a transfer case operatively connected to the transmission, and operable for establishing a predetermined transfer case mode, wherein the predetermined transfer case mode is one of a four-wheel drive high mode and a two-wheel drive high mode;
a mode selection device operable for receiving a requested crawl mode of the vehicle while in the predetermined transfer case mode;
a plurality of road wheels;
an electronic brake assembly having a brake motor and a plurality of brake calipers in fluid communication with the brake motor, wherein each brake caliper is disposed proximate a respective one of the road wheels and is operable for braking the respective road wheel; and
a controller in communication with the mode selection device and programmed to execute the requested crawl mode in the predetermined transfer case mode by simulating a four-wheel drive-low mode of the transfer case, including controlling the brake motor and brake calipers to decelerate the vehicle, limiting a gear state of the transmission to 1^{st} or 2^{nd} gear, disabling the auto-start/stop functionality, and engaging an automatic vehicle hold function via control of the electronic brake assembly after the vehicle has slowed to a stop to prevent the vehicle from rolling on an inclined surface.

16. The vehicle of claim 15, further comprising a door switch sensor and a seat belt switch sensor, wherein the controller is programmed to engage a parking brake and release the electronic brake assembly when the door switch sensor detects an open door of the vehicle and the seat belt switch sensor detects an unlatched seat belt of the vehicle.
